(19) United States
(12) Patent Application Publication
(10) Pub. No.: US 2003/0063116 A1
(43) Pub. Date: Apr. 3, 2003

(54) Presentation of personalized merchandise in an electronic commerce transaction using visual matching

(76) Inventor: Robert L. Parker, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/970,545

(22) Filed: Oct. 3, 2001

(51) Int. Cl. G09G 5/00

(52) U.S. Cl. 345/719; 345/744

(57) ABSTRACT

A method of presenting a personalized image to a user includes displaying a first image on a web page, selecting an image of a three dimensional mesh, sizing and positioning the three dimensional mesh image over a selected area of the first image, projecting a second image onto the first image using the selected three dimensional mesh image as sized and positioned to form a composite image, and displaying the composite image to a user for accessing in an electronic commerce transaction.

### FIELD

The invention relates to electronic commerce transactions, and, more particularly, to using visual matching to produce an image of personalized merchandise by combining a first image and a second image.

### BACKGROUND

The rise of public data networks, and the World Wide Web portion of the Internet in particular, has provided opportunity for the marketing of digital photos and services related thereto. Often, the images offered online are provided “as is”, with no opportunity for a person to customize, personalize, or otherwise alter the image. With “personalization”, a person is provided the opportunity to specify artwork, patterns, decals, logos, text, images, and so on to apply to images. Personalization provides that “personal touch” which may sway a person toward a particular service.

Techniques for providing a realistic representation of a personalized image on, for example, a web page, may help improve the online shopping experience, and thus lead to increased sales for electronic commerce.

### FIGURES

The invention may be better understood with reference to the following figures in light of the accompanying description. The present invention, however, is limited only by the scope of the claims at the concluding portion of the specification.

FIG. 1 shows an example web page in accordance with an embodiment of the present invention.

FIG. 2 shows an example web page with matching objects in accordance with an embodiment of the present invention.

FIG. 3 shows an example web page using visual matching in accordance with an embodiment of the present invention.

FIG. 4 shows an example web page after projection of content onto a first image in accordance with an embodiment of the present invention.

FIG. 5 shows another example web page in accordance with an embodiment of the present invention.

FIG. 6 shows the second example web page with a selected mesh sized and positioned over a portion of an image upon which to apply a design according to an embodiment of the present invention.

FIG. 7 shows the second example web page after projection of the design onto the image in accordance with an embodiment of the present invention.

FIG. 8 shows a system supporting presentation of personalized merchandise in accordance with an embodiment of the present invention.

### DESCRIPTION

In the following description, references to “one embodiment” or “an embodiment” do not necessarily refer to the same embodiment, although they may. Various operations of the description below and the claims are described in terms of software, e.g. instructions executed by a processor, either a general purpose processor, or a more task-specific processor such as an embedded processor or digital signal processor. However, the various operations may of course be embodied by software, hardware, firmware, or a combination thereof.

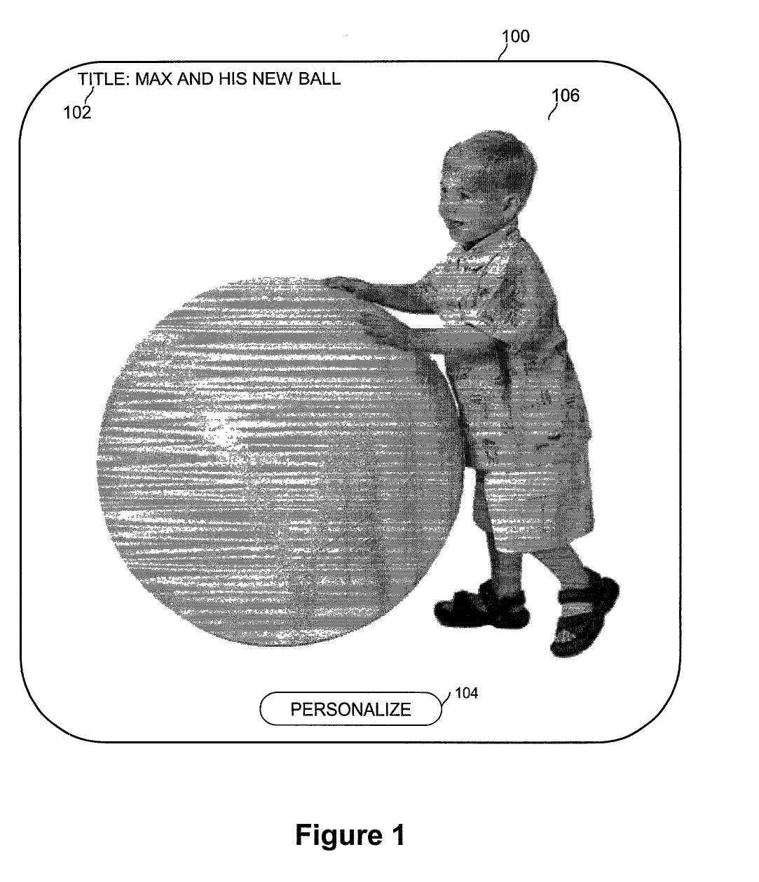

FIG. 1 shows an example of a web page 100 in accordance with an embodiment of the present invention. Web page 100 may be displayed on a display of a personal computer (PC) or other device using a well-known web browser application program. A user accessing the web page may provide an image 106. Alternatively, the image 106 may be provided by the entity operating the web site of which the web page is a part and the user may select the image from a set of images. The image may represent anything the user wishes to personalize. In other instances, the image may represent an item of merchandise for sale or otherwise available from the web site. A reference to the image 106, or the image 106 itself, may be incorporated into the web page 100 such that the image 106 is displayed when the web page 100 is rendered by a web browser or other mechanism for displaying web pages. One example of an image 106 is a digital photograph. The user may also provide a title 102 for the image 106. A control button 104 or other user interface item may be provided to enable the user to select to personalize the image 106.

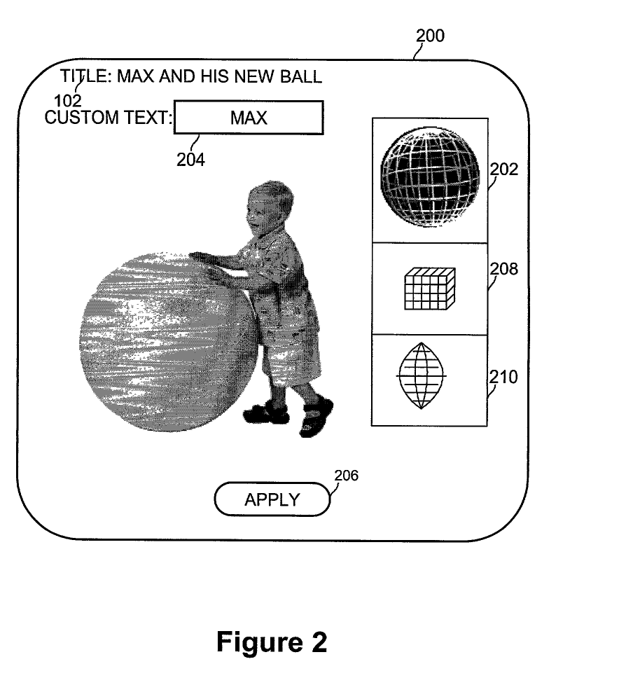

FIG. 2 shows an example web page with matching objects in accordance with an embodiment of the present invention. The user who provided the image may be prompted to provide custom text 204 to apply to the image 106. Text is merely one example of the content that could be applied to the image. Other examples include another image, logos, stencils, patterns, and other types of designs and artwork. In this embodiment the boy in the image 106 is named “Max” and he is playing with a ball.

In this example, the custom text 204 comprises the boy's name, “Max”. In accordance with an embodiment of the present invention, the custom text 204 may be applied to the ball in the image 106 such that the text 204 appears to conform to the shape of the ball. This may be referred to “surface mapping” the text 204 to the ball.

The may be provided with meshes 202, 208, and 210. Each mesh 202, 208, and 210 may be characterized by a surface function, e.g., a mathematical description of the surface of the mesh in space. Although three distinct shapes of meshes are shown in this example, any number and type of three-dimensional (3D) meshes known in the computer graphics art may be employed. For example, meshes in the shapes of cylinders, rods, cubes, sheets, ovals, other complex shapes, and so on, may be used. The user may select from among the meshes 202, 208, and 210, a particular mesh representing a surface that roughly approximates the shape and curvature of the area of the image 106 at which the user desires to apply the text 204. Once a mesh is selected, the user may select an apply control button 206 or other suitable user interface mechanism to cause the selected mesh to be applied to an area of the image 106.

Meshes are only one manner by which the surface characteristics of an image or a portion of an image may be approximated and described. In other embodiments, other types of descriptors such as text, mathematical formulas, pictures, and so on may also be employed for this purpose.

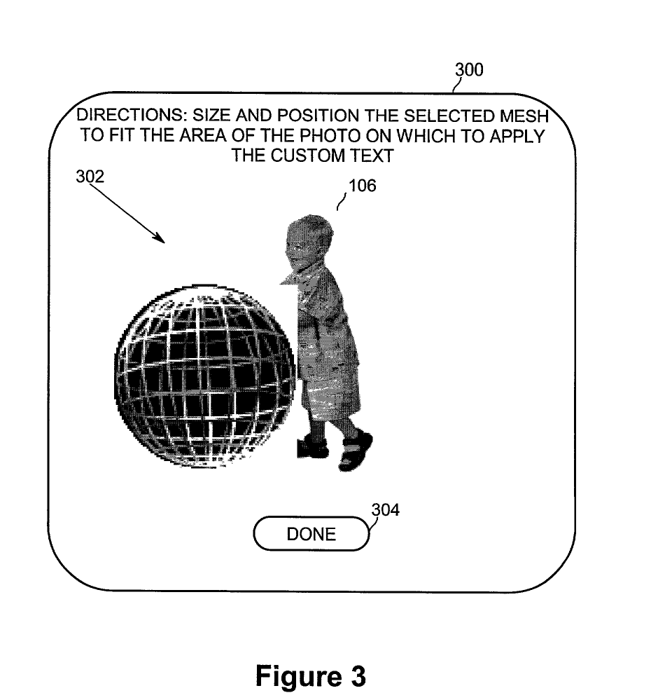

FIG. 3 shows an example web page using visual matching in accordance with an embodiment of the present invention. The user sizes and positions the selected mesh 302 to correspond to the portion of the image 106 on which to apply the text 204. In this example, the user selected a spherical 3D mesh, which approximates the spherical curvature and shape of the ball in the image 106. Selection and positioning of the selected mesh may be accomplished using, a mouse, trackball, or other known user input mechanism. The person may select control button 304 or other suitable user interface mechanism to proceed.

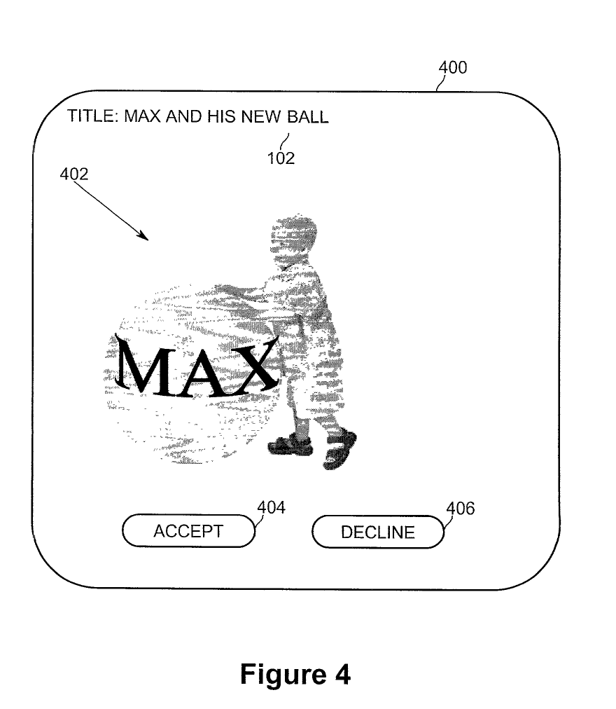

FIG. 4 shows an example web page after projection of content onto a first image in accordance with an embodiment of the present invention. Pixels representing the text 204 may be generated and may be applied, according to a surface function of the selected mesh 302, to the portion of the image 106 representing the ball (in this example). Consequently, an image 402 may be produced in which the text 204 appears to wrap around the surface of the ball in the image 106, as though the text 204 were on the ball when the picture of the ball was captured. The projection may be accomplished through any one of several well-known techniques of 3D computer graphics.

The user may accept the composite image 402 formed by the projection of text 204 onto image 106 by selecting control button 404. The user may reject the image 402 be selecting control button 406. Once accepted, the user may complete an electronic commerce transaction by paying a fee or by providing other remuneration in order to print or download the personalized composite image 402. Of course, revenue models of a service to provide customized images are varied and diverse. Other possibilities include exposing the user to paid advertising, offering the service only to paid subscribers, and so on.

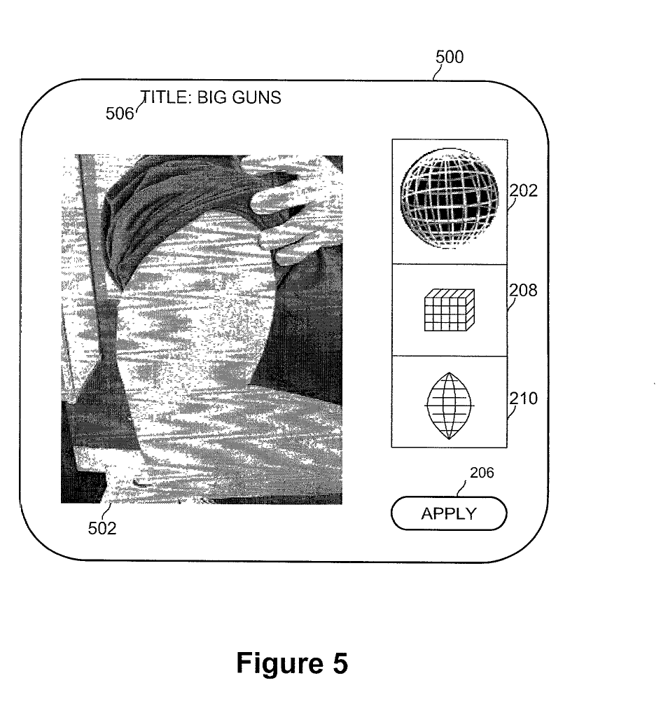

FIG. 5 shows another example web page in accordance with an embodiment of the present invention. FIG. 5 illustrates one application of an embodiment of the present invention. The web page 500 provides a “virtual tattoo” service. An image 502 (e.g., a digital photograph) of a body part of a human being may be provided by a user accessing the service. The user may also provide or otherwise select a predetermined design (not shown in FIG. 5). A design may be applied to the image 502 of the body part as a virtual tattoo. The user may also provide a title 506. In various embodiments, the design applied as a tattoo may be any image or artistic design provided by the user or selected from a set of available images provided by the web site.

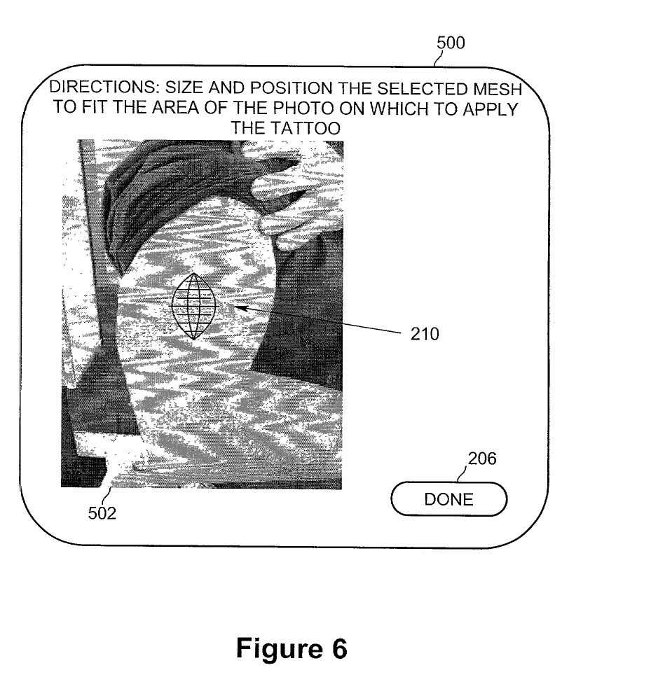

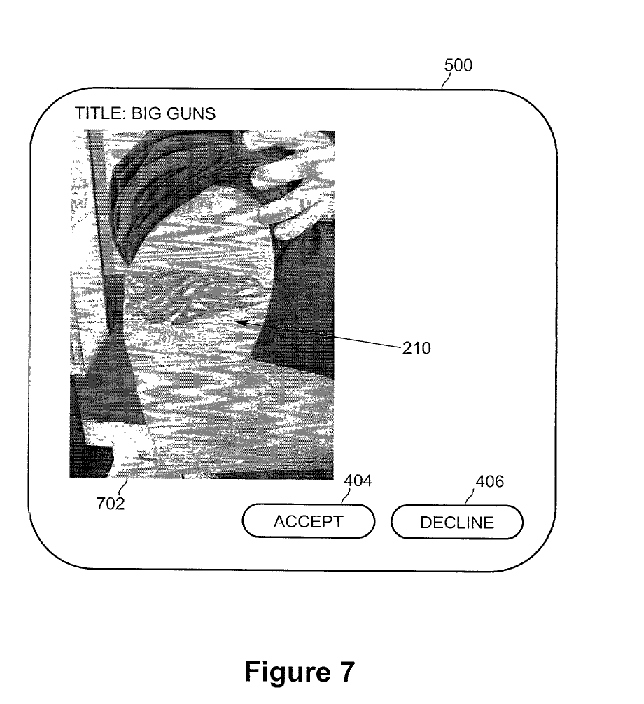

FIG. 6 shows the second example web page with a selected mesh 210 sized and positioned over a portion of an image 502 upon which to apply the design according to an embodiment of the present invention. The surface function of the selected mesh 210 may roughly approximate the shape and curvature of the body part. Pixels representing the design may be generated and applied, according to the surface function of the selected mesh 210, to the portion of the image 502 representing the area upon which to apply the tattoo. Referring to FIG. 7, according to an embodiment of the present invention, an image 702 may be produced in which the design appears to wrap around the surface of the body part, as though the design were a tattoo on the body part when the picture of the body part was captured. The result may resemble a realistic virtual tattoo of the design on the body part in the image 702. The user may accept or decline the new image using accept control button 404 and decline control button 406. The image with the virtual tattoo 702 may then be made available for download by the user in return for value in an electronic commerce transaction or for free. Alternatively, the user may purchase physical application of the real tattoo based on the virtual tattoo presented by the web site.

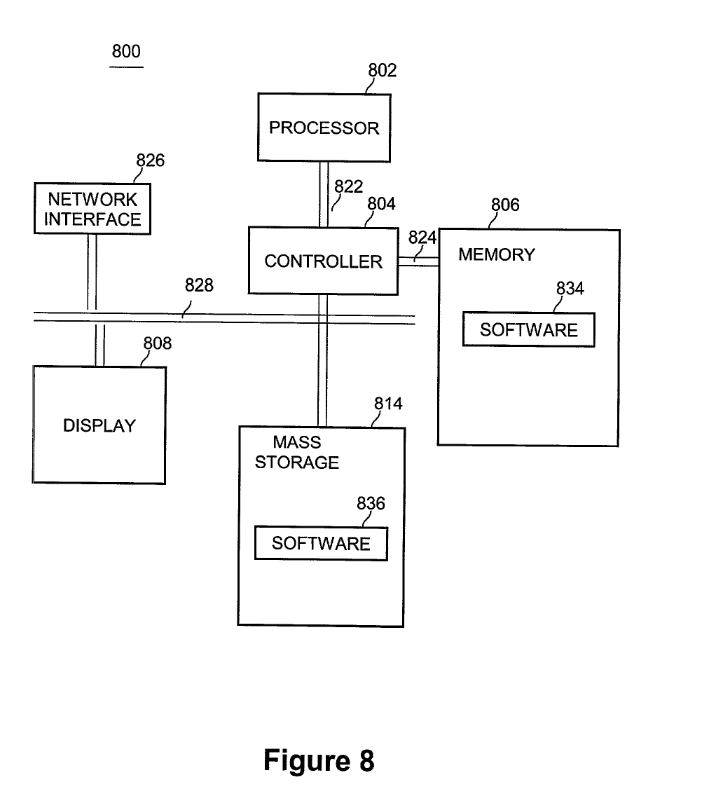

FIG. 8 shows a system supporting presentation of personalized merchandise in accordance with an embodiment of the present invention. Embodiment 800 comprises a processor 802 coupled to a controller 804 by way of a processor bus 822, commonly referred to as a front side bus. Bus controller 804 may be coupled to memory 806 via memory bus 824. Bus controller 804 may also be coupled to various peripheral devices such as mass storage 814, network interface 826, and display 808 via I/O bus 828. Network interface 826 provides apparatus 800 with access to networks such as the Internet or corporate intranets. Memory 806 stores a software embodiment 834 to perform operations to implement the production of an image as herein described and in accordance with the present invention. Software 834 may be stored in memory 806 in a form suitable for access and execution by processor 802. An archived loadable form 836 of software 834 may be stored by mass storage 814 for loading into memory 806 for execution by processor 802. Mass storage 814 may comprise any form of non-volatile memory including hard drives, CD ROM drives, ZIP drives, diskettes, and so on.

Memory 806 is typically a form of random access memory (RAM) such as a DRAM, flash memory, SDRAM, and so on. Memory 806 supplies the instructions of software 834 stored therein to processor 802 for execution. Execution of software embodiment 834 by processor 802 may result in a process to perform operations to implement production and presentation of a personalized image, as herein described and in accordance with the present invention.

Of course, those skilled in the art will appreciate that other embodiments could comprise different combinations of software, hardware, and firmware than those illustrated to carry out the operations of the present invention as well.

While certain features of the invention have been illustrated as described herein, many modifications, substitutions, changes and equivalents will now occur to those skilled in the art. It is, therefore, to be understood that the appended claims are intended to cover all such embodiments and changes as fall within the true spirit of the invention.

What is claimed is:

1. A method comprising:
displaying a first image on a web page;
selecting an image of a three dimensional mesh;
sizing and positioning the three dimensional mesh image over a selected area of the first image;
projecting a second image onto the first image using the selected three dimensional mesh image as sized and positioned to form a composite image; and
displaying the composite image to a user for accessing in an electronic commerce transaction.

2. The method of claim 1, wherein the first image comprises a digital photograph provided by the user, and the second image comprises text provided by the user.

3. The method of claim 1, further comprising accepting or declining the composite image by the user.

4. The method of claim 1, further comprising purchasing the composite image by the user in an electronic commerce transaction.

5. The method of claim 1, wherein the first image comprises an image of a body part of a human being.

6. An article comprising:
a machine-accessible medium comprising instructions which, when executed by a processor, cause:
displaying a first image on a web page;
selecting an image of a three dimensional mesh;
sizing and positioning the three dimensional mesh image over a selected area of the first image;
projecting a second image onto the first image using the selected three dimensional mesh image as sized and positioned to form a composite image; and
displaying the composite image to a user for accessing in an electronic commerce transaction.

7. The article of claim 6, wherein the first image comprises a digital photograph provided by the user, and the second image comprises text provided by the user.

8. The article of claim 6, further comprising instructions for accepting or declining the composite image by the user.

9. The article of claim 8, further comprising instructions for purchasing the composite image by the user in an electronic commerce transaction.

10. The article of claim 8, wherein the first image comprises an image of a body part of a human being.

11. A method of presenting a personalized image to a user comprises:
receiving a digital photograph from the user;
receiving a first image from the user;
providing a set of three dimensional mesh images;
accepting a user selection for a selected one of the mesh images;
accepting sizing and positioning of the selected mesh image over a selected area of the digital photograph;
projecting the first image onto the selected area of the digital photograph using the selected mesh image to form the personalized image; and
displaying the personalized image to the user.

12. The method of claim 11, wherein the first image comprises text.

13. The method of claim 11, further comprising offering the personalized image for sale to the user in an electronic commerce transaction.

14. The method of claim 11, wherein the digital photograph comprises an image of at least one body part of a human being and the first image comprises at least one of text, an artistic design, and a logo.

15. An article comprising:
a machine-accessible medium comprising instructions which, when executed by a processor, cause presentation of a personalized image to a user by receiving a digital photograph from the user, receiving a first image from the user, providing a set of three dimensional mesh images, accepting a user selection for a selected one of the mesh images, accepting sizing and positioning of the selected mesh image over a selected area of the digital photograph, projecting the first image onto the selected area of the digital photograph using the selected mesh image to form the personalized image; and displaying the personalized image to the user.

16. The article of claim 15, further comprising instructions for offering the personalized image for sale to the user in an electronic commerce transaction.

17. The article of claim 15, wherein the digital photograph comprises an image of at least one body part of a human being and the first image comprises at least one of text, an artistic design, and a logo.
